(19) United States
(12) Patent Application Publication
(10) Pub. No.: US 2013/0078999 A1
(43) Pub. Date: Mar. 28, 2013

(54) DELAY OF ACCESS TO ASSIST MANAGEMENT OF CONGESTION IN RADIO ACCESS NETWORKS

(71) Applicants: Brian Martin, Surrey (GB); Jianke Fan, Espoo (FI)

(72) Inventors: Brian Martin, Surrey (GB); Jianke Fan, Espoo (FI)

(73) Assignee: Renesas Mobile Corporation, Tokyo (JP)

(21) Appl. No.: 13/246,358

(22) Filed: Sep. 27, 2011

(51) Int. Cl. H04W 72/12; H04W 4/00

(52) U.S. Cl. 455/426.2; 455/452.1

(57) ABSTRACT

A radio access network includes user equipments configured to one of several classes, and is capable of being configured to bar access, at least temporarily, from a user equipment according to its class in order to reduce congestion, by transmitting equipment class barring data which indicates at least one class of user equipment which is to be barred. A user equipment receives signalling data including an equipment class access barring data item, and one or more additional data items indicative of loading of the radio access network. The user equipment matches its class to the equipment class barring data item, and in response to the matching, sets a barred status at the user equipment. In response to the barred status setting, the user equipment determines a delay time for an attempt to access the radio access network, based at least in part upon the one or more additional data items.

### TECHNICAL FIELD

The present invention relates generally to wireless systems, and more specifically, but not exclusively, to a method and apparatus relating to delay of access for determined classes of user equipment to reduce overload of a radio access network.

### BACKGROUND

Cellular wireless networks typically comprise user equipments (UE) such as mobile handsets which may communicate via a network interface comprising a radio transceiver to a network of base stations connected to a telecommunications network. Such cellular wireless networks have undergone rapid development through a number of generations of radio access technology. The initial deployment of systems using analogue modulation has been superseded by second generation (2G) digital systems such as GSM (Global System for Mobile communications), implementing GERAN (GSM Enhanced Data rates for GSM Evolution Radio Access Network) radio access networks, and these systems have themselves been replaced by or augmented by third generation (3G) digital systems such as UMTS (Universal Mobile Telecommunications System), implementing the UTRAN (Universal Terrestrial Radio Access Network) radio access networks. Third generation standards provide for a greater throughput of data than is provided by second generation systems; this trend is continued with the proposals by the Third Generation Partnership Project (3GPP) of the Long Term Evolution (LTE) system, implementing E-UTRAN (Evolved UTRA) radio access networks, which offer potentially greater capacity and additional features compared with the previous standards. Wimax systems according to IEEE 802.16 standards have also evolved to provide high capacity cellular radio access networks.

In addition to user equipment intended to be carried by a person using the service, there are also other types of user equipment, such as user equipment intended for automatic sending of data, for applications such as, for example, meter reading and monitoring of industrial installations such as pipelines. User equipment intended for automatic sending of data may be referred to as Machine Type Communication (MTC) user equipment, and such equipment may be allocated an access class by the radio access network, typically in the range of Access Classes 0-9 for MTC user equipment in the LTE system. Typically, MTC user equipment may tolerate a delay in accessing the radio access network. The network may be capable of barring access, at least temporarily, to user equipment according to access class in order to manage network congestion at times of high usage of network resource. The barring of access classes may be prioritised in terms of the order in which classes barred at times of network congestion. Network congestion includes network overload conditions that may result in jamming of access to the network.

In existing systems, access for a user equipment of a given access class may be inhibited by allocating a probability of connecting to the network at each attempt from the network to user equipments, the decision as to whether or not to connect to the network being made typically at the user equipment on the basis of the allocated probability and the generation of a random number which is arranged to fall with the allocated probability into a range indicating that network connection may be attempted. If the random number falls into a range that indicates that the user equipment should not be connected to the network, another attempt at connection may be made after a delay. However, this method suffers from a long tail to the probability distribution of delay experienced by a user equipment, so that there is a significant probability that a delay may fall outside a desired range. In an alternative scheme, a maximum delay parameter may be specified, and the user equipment may randomly select a delay value up to the maximum value. However, this scheme may impose a long delay in times when congestion is moderate.

It is an object of the invention to address at least some of the limitations of the prior art systems.

### SUMMARY

In accordance with a first exemplary embodiment of the present invention, there is provided a method of assisting management of congestion in a radio access network comprising at least a plurality of user equipments, each of said plurality of user equipments being configured to have one of a plurality of classes, and the radio access network being capable of being configured to bar access, at least temporarily, from a respective user equipment according to the class of the respective user equipment in order to reduce congestion, by transmitting equipment class barring data which indicates at least one class of user equipment which is to be barred,

the method comprising, at a user equipment:

holding user equipment class data indicating a given class of the user equipment;

receiving signalling data including an equipment class access barring data item which indicates that said given class of user equipment is to be barred, and one or more additional data items indicative of loading of the radio access network;

matching the given user equipment class to said equipment class barring data item, and in response thereto setting a barred status at the user equipment; and

in response to said barred status setting, determining a delay time for an attempt to access the radio access network, based at least in part upon said one or more additional data items.

In accordance with a second exemplary embodiment of the present invention, there is provided user equipment for assisting management of congestion in a radio access network comprising at least a plurality of user equipments, each of said plurality of user equipments being configured to have one of a plurality of classes, and the radio access network being capable of being configured to bar access, at least temporarily, from a respective user equipment according to the class of the respective user equipment in order to reduce congestion, by transmitting equipment class barring data which indicates at least one class of user equipment which is to be barred,

the user equipment comprising at least one processor and at least one memory including computer program code, the at least one memory and the computer program code configured to, with the at least one processor, cause the user equipment to at least:

hold user equipment class data indicating a given class of the user equipment;

receive signalling data including an equipment class access barring data item which indicates that said given class of user equipment is to be barred, and one or more additional data items indicative of loading of the radio access network;

match the given user equipment class to said equipment class barring data item, and in response thereto setting a barred status at the user equipment; and

in response to said barred status setting, determine a delay to an attempt to access the radio access network by a delay time, based upon the received one or more additional data items.

In accordance with a third exemplary embodiment of the present invention, there is provided apparatus for assisting management of congestion in a radio access network comprising at least a plurality of user equipments, each of said plurality of user equipments being configured to have one of a plurality of classes, and the radio access network being capable of being configured to bar access, at least temporarily, from a respective user equipment according to the class of the respective user equipment in order to reduce congestion, by transmitting equipment class barring data which indicates at least one class of user equipment which is to be barred,

the apparatus comprising at least one processor and at least one memory including computer program code, the at least one memory and the computer program code configured to, with the at least one processor, cause the apparatus to at least:

transmit an equipment class access barring data item which indicates that said given class of user equipment is to be barred;

determine a parameter indicative of loading of the radio access network;

transmit said parameter, along with said equipment class access barring data item, to delay an attempt to access the radio access network by a barred class of user equipment dependent on said parameter.

Further features and advantages of the invention will be apparent from the following description of preferred embodiments of the invention, which are given by way of example only.

### BRIEF DESCRIPTION OF THE DRAWINGS

FIG. 1 is a schematic diagram showing a radio access network according to an embodiment of the invention;

FIG. 2 is a flow diagram of a method according to an embodiment of the invention;

FIG. 3 is a diagram illustrating timing of re-checking access class barring in an embodiment of the invention;

FIG. 4 is a diagram illustrating selection of a delay value in an embodiment of the invention;

FIG. 5 is a schematic diagram of a user equipment in an embodiment of the invention; and

FIG. 6 is a schematic diagram of apparatus in an embodiment of the invention.

### DETAILED DESCRIPTION

By way of example an embodiment of the invention will now be described in the context of a wireless communications system supporting communication using E-UTRA radio access technology, as associated with E-UTRAN radio access networks in LTE systems. However, it will be understood that this is by way of example only and that other embodiments may involve wireless networks using other radio access technologies, such as UTRAN, GERAN or IEEE802.16 WiMax systems.

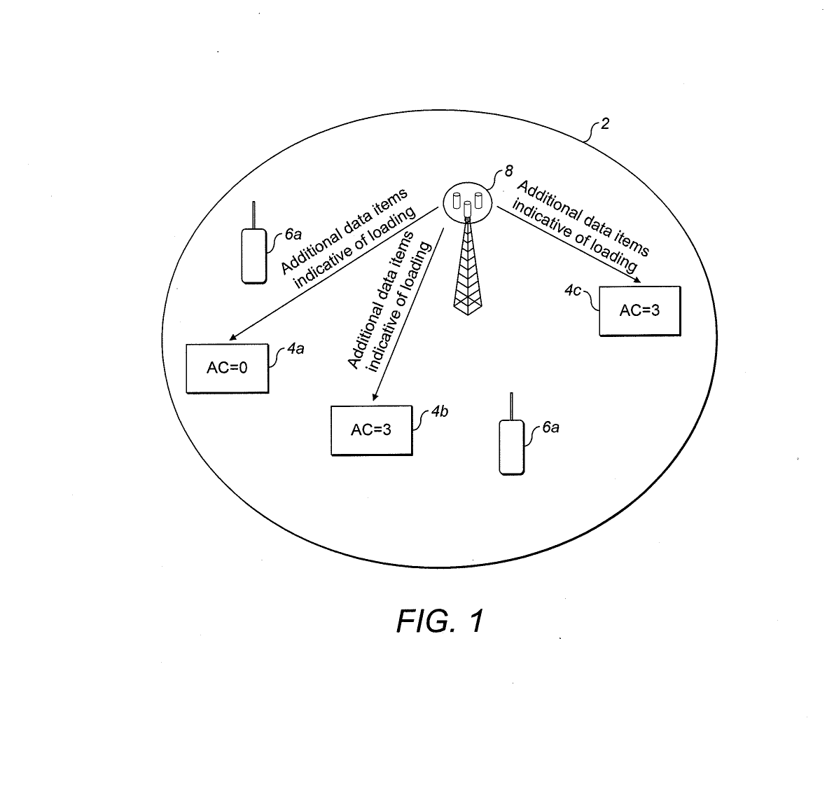

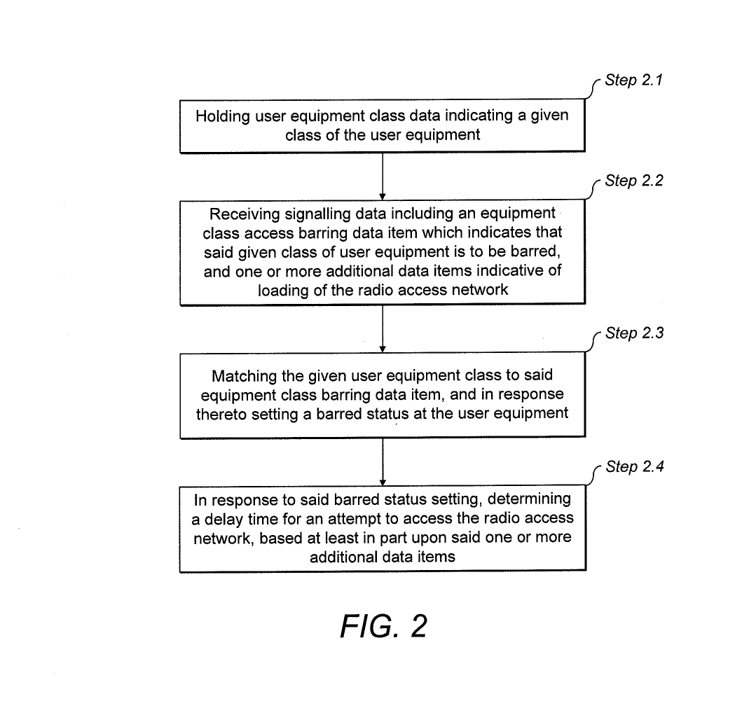

FIG. 1 shows a radio access network 2 according to an embodiment of the invention, in which there are several Machine Type Communication (MTC) user equipments 4a, 4b, 4c. Each of the MTC user equipments 4a, 4b, 4c have an access class allocated by the network, the access classes being typically in the range 0 to 9. In the example shown in FIG. 1, one of the user equipments has access class 0, and two user equipments have access class 3. The radio access network is capable of being configured to bar access from a user equipment according to the class of the user equipment, in order to reduce congestion. The barring of access to the radio access network may take the form of introducing a delay to the access. So, for example, in periods of high congestion, in which a large number of user equipments are attempting access and a shortage of radio resource may potentially cause jamming of attempts to connect to the network, access may be barred from, say, access classes 0 to 7, whereas in periods of less severe congestion, access may barred from, say, access classes 0 to 2. Typically, access from non-MTC type user equipment, such as telephone handsets 6a, 6b, would not be barred. In this way, at times of congestion, access from types of user equipment that can typically tolerate a delay to transmission may be barred, at least temporarily, so that connection of other types of user equipment to the radio access network may avoid jamming and may connect to the network successfully. In embodiments of the invention, access from types of user equipment configured for non-MTC applications may also be barred, and furthermore, not all MTC user equipment need necessarily be configured for access barring. Signalling data is transmitted by the network including equipment class barring data items indicating a class or classes of user equipment to be barred. If a user equipment is configured with a class matching a received barring data item indicating that the class is to be barred, a barred status is set at the user equipment. One or more additional data items relating to loading of the radio access network is also transmitted, and is received from the radio access network, typically at a user equipment 4a, 4b, 4c. In an embodiment of the invention, the one or more additional data items may comprise a parameter determined from knowledge of which class or classes of user equipment have access to the cell barred by the configuration of the radio access network. The parameter may be determined in a fixed infrastructure part 8 of the radio access network and sent to the user equipment, and a delay to an attempt to access the radio access network by a delay time is determined, in response to the barred status setting, typically at the user equipment 4a, 4b, 4c, based upon the received one or more additional data items. The parameter may be, for example, a maximum delay time. This process is illustrated by FIG. 2, as steps 2.1, 2.2, 2.3 and 2.4.

This has an advantage that the delay time may be related to to the loading of the radio access network, for example by scaling according to the loading, so that at times when the loading of the radio access network may lead to moderate levels of congestion or jamming the delay may be reduced in comparison with the delay at time when the loading of the radio access network may lead to severe levels of congestion or jamming.

The parameter may be determined by quantifying a total number of classes of user equipment for which access to the cell is barred. So, for example, if only classes 0 and 1 are barred, it may be determined that the network congestion is lower than if, say, classes 0 to 7 are barred. As a result, a larger delay time may be applied.

Alternatively, the parameter may be determined on the basis of the barred class which indicates the most heavily loaded state of the radio network.

In an alternative embodiment, the one or more additional data items comprise user equipment barring data, for example a list of access classes having access to the cell barred. In this case, the parameter determined from knowledge of which class or classes of user equipment have access to the cell barred by the configuration of the radio access network may be determined at the user equipment from the received one or more additional data items. In this alternative embodiment, a delay to an attempt to access the radio access network by a delay time is determined, typically at the user equipment, based upon the received one or more additional data items, and in this case based on the parameter, such as a maximum delay time, calculated from the received one or additional data items at the user equipment. This has an advantage that the network need not send the parameter to the user equipment.

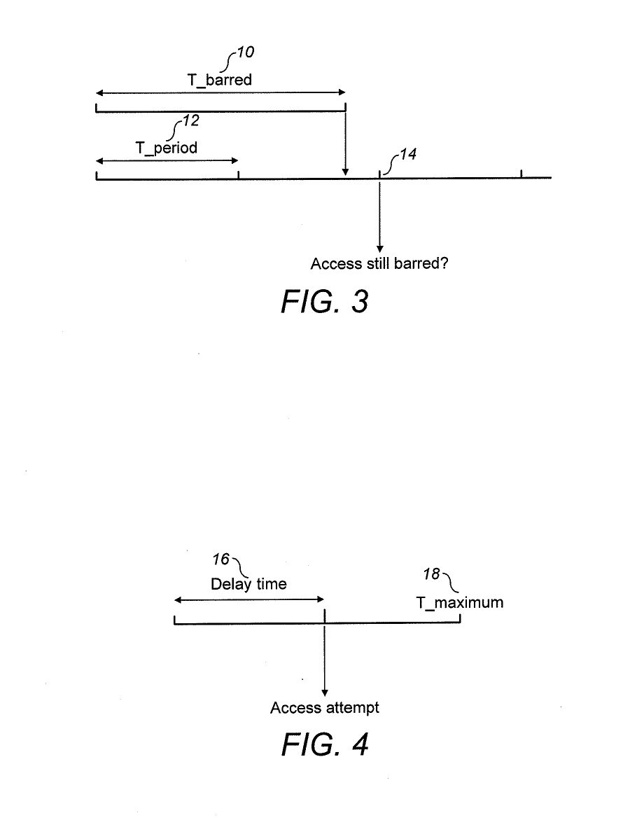

The delay time may be related to the determined parameter, whether it is determined by a part of the fixed infrastructure of the network, or calculated at the user equipment, by a predetermined relationship such as a constant multiple, which may be 1. So, the delay time applied to an attempt by a user equipment of a barred class to connect to the radio access network may simply be scaled by the number of barred classes. For example, the delay time may be a barring time, dependent on the determined parameter, that may be referred to as T_barred. In this case, a user equipment of a barred class may wait for the barring time, and on expiry of the barring time will check again whether the class remains barred. As illustrated in FIG. 3, there may be an additional delay after the expiry of the barring time 16 before the user equipment checks again whether the class remains barred, as the user equipment may wait for an integer multiple of a period T-period that may typically be decided by a scheduled transmission period of the user equipment before performing the check and a subsequent transmission if the class is not barred. If the class remains barred, the user equipment may wait for at least a further barring time, before checking the barring status again.

Alternatively, as illustrated by FIG. 4, the delay time 16 may be determined to fall in a range of values, up to a maximum delay, T_maximum 18. In this case, the maximum value of a range of delay times is determined from the parameter, and the delay time is selected from the range of delay times according to a pseudo-random process, for example on the basis of the generation of a random number. After expiry of the selected delay time, the user equipment will attempt to access the radio access network.

The parameter may represent the maximum value of the range of delay times, or the maximum value of the range of delay times may be determined from the parameter by multiplication of the parameter by a constant. Alternatively, the maximum value of the range of delay times may be determined by multiplication of a constant by a two raised to the power of the parameter.

In an embodiment of the invention, the delay is determined to depend also on the class of the user equipment having its attempt to connect to the network barred. For example, the maximum delay may be scaled to a larger value for a class of user equipment more tolerant of delay, or the delay may be scaled by an arbitrary factor according to the class. For example, a delay scaling factor for a given class may be sent to the user equipment from the network. Additionally, or alternatively, the delay may be determined to depend on a category of the user equipment, the category relating to whether the radio access network is part of the Home Public Land Mobile Network (HPLMN) for the first user equipment. So, for example, if the radio access network is part of the Home Public Land Mobile Network (HPLMN) for a user equipment, the user equipment may be allocated a shorter delay than a user equipment for whom the radio access network is part of a Visited Public Land Mobile Network (VPLMN).

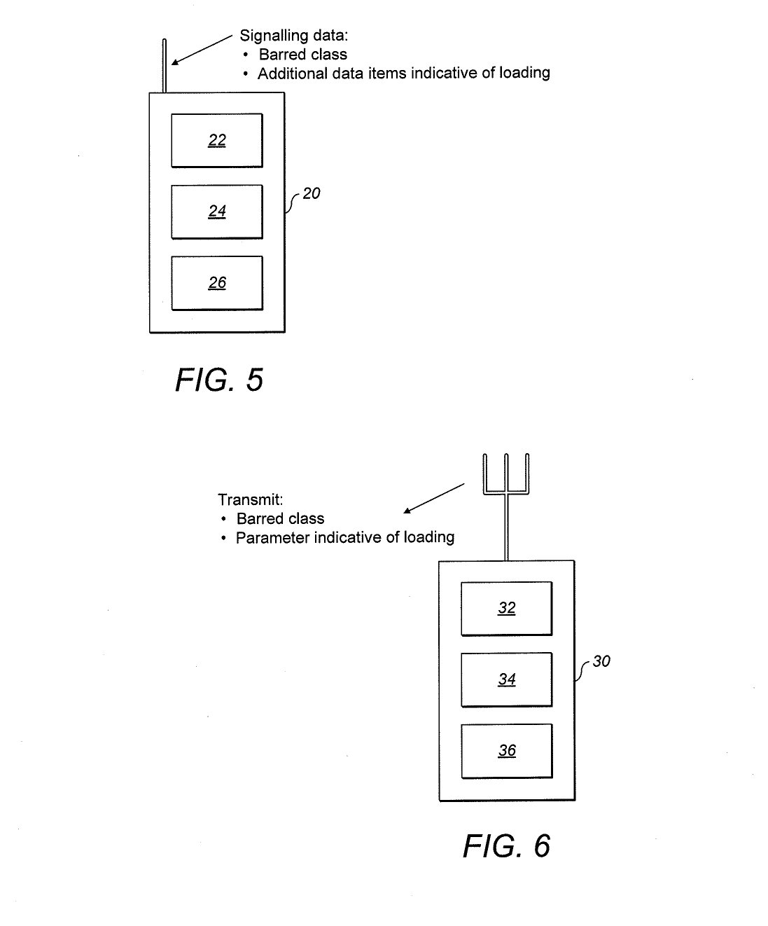

FIG. 5, illustrates a user equipment 20 according to an embodiment of the invention. The user equipment is for assisting management of congestion in a radio access network comprising user equipments configured to have one of a plurality of classes, typically access classes, and the radio access network can be configured to bar access, at least temporarily, from a respective user equipment according to its class to reduce congestion, by transmitting equipment class barring data which indicates at least one class of user equipment which is to be barred.

As shown in FIG. 5, in an embodiment of the invention, the user equipment comprises at least one processor 24 and at least one memory 26 including computer program code, the at least one memory 26 and the computer program code configured to, with the at least one processor 24, cause the user equipment to at least hold user equipment class data indicating a given class of the user equipment, and receive, for example using a receiver 22, signalling data including an equipment class access barring data item which indicates that said given class of user equipment is to be barred, and one or more additional data items indicative of loading of the radio access network.

The user equipment is configured to match the given user equipment class to the equipment class barring data item, and in response to set a barred status at the user equipment. In response to the barred status setting, the user equipment determines a delay to an attempt to access the radio access network by a delay time, based at least in part upon said one or more additional data items.

FIG. 6 illustrates apparatus 30, such as a fixed infrastructure part of the radio access network, for example a base station, according to an embodiment of the invention. The apparatus comprises at least one processor 34 and at least one memory 36 including computer program code, the at least one memory 36 and the computer program code configured to, with the at least one processor 34, cause the apparatus to at least transmit, for example using a transmitter 32, an equipment class access barring data item which indicates that the given class of user equipment is to be barred, and to determine a parameter indicative of loading of the radio access network. The parameter is then transmitted, along with the equipment class access barring data item, to delay an attempt to access the radio access network by a barred class of user equipment dependent on the parameter.

The parameter may be determined from knowledge of which class or classes of user equipment have access to the radio access network barred by the configuration of the radio access network, and the parameter may be determined by quantifying a number of classes of user equipment for which access to the radio access network is barred.

Embodiments of the invention will now be described in more detail. Existing LTE radio access networks, that is to say E-UTRAN networks, typically use an Access Class Barring (ACB) scheme that uses two parameters: a probability factor (ac-BarringFactor), and a time factor (ac-BarringTime). If a random number drawn by the UE is lower than ac-BarringFactor, access is allowed. Otherwise the access is barred. If access is barred then the UE starts a timer calculated by multiplying a random number by the mean barring time ac-BarringTime, which has the effect of distributing the access attempts from different UEs in time. A disadvantage of the above scheme is that it results in a delay that follows an approximately geometric distribution, so that the probability of a delay value is non-zero even at very large values of delay. When there are many user equipments subject to call barring using this scheme, a significant number of user equipment devices may end up choosing from the tail of the delay distribution and hence incur in an excessive access delay.

Existing UMTS radio access networks, that is to say UTRAN networks, typically use a Access Class (AC) bitmap that indicates which of the ACs 0-15 is barred or unbarred. Access Classes 0-9 are used for standard user equipment and the 10 classes have the same priority. Access Classes 11-15 are allocated to higher priority users such as public organisations or users subscribing to security services, for example. Access Class 10 indicates whether or not network access for emergency calls is allowed for UEs with access classes 0 to 9 with or without an International Mobile Subscriber Identity (IMSI). The UMTS scheme typically results in a granularity of barring of 10% of all standard user equipment configured for Access Class barring at a given time, since a class may be either barred or unbarred. Furthermore, when the radio access network changes the access classes which are barred, user equipments with pending, i.e delayed due to barring, transmission may all attempt access almost simultaneously, which may cause overload of the radio access network.

In currently proposed enhancements of the LTE and UMTS schemes, access attempts may be delayed by choosing a random delay T_barred in the range 0 to T_Maximum. This has the advantage of providing a uniform distribution of delays up to a defined maximum value of delay.

In an embodiment of the invention, the “T_Maximum” delay, which may correspond to the one or more additional data items referred to already, or which may be a parameter calculated at the user equipment on the basis of the one or more additional data items, is calculated by scaling a constant value, which may be signalled by the network, by the number of access classes in the range 0-9 which are barred. The constant value may also be scaled according to a category of user equipment. Hence, the average delay and maximum delay a UE experiences is increased depending on the severity of a congestion or overload situation, and/or the category of user equipment. This limits unnecessary delays. The category may refer to whether or not the user equipment is camped in its Home Public Land Mobile Network (HPLMN), that is to say whether the radio access network is part of the HPLMN.

There may be two modes of operation for Access Class Barring: either access attempts may be barred for a certain class or classes of user equipment by a fixed delay time; this is so called “barred mode”, or access attempts for a certain class or classes or user equipment may be spread over time up to a maximum value of delay, in so called “spread mode”.

In barred mode, once the user equipment is barred, the user equipment waits for an expiry of a time interval T_barred and then checks whether System Information (SI) is changed or not. If the System Information has not changed in relation to the barred classes, the user equipment waits for a further time interval. In an embodiment of the invention relating to barred mode, T_barred will be scaled according to loading of the radio access network, which may be according to the severity of an overload situation. The loading may relate to a cell of the radio access network.

In spread mode, the UE is not barred for the duration of “T_barred”, but the access is typically delayed by a random amount which is in the range 0 to T_Maximum. In an embodiment of the invention related to spread mode, T_Maximum is scaled according to loading of the radio access network, which may be according to the severity of an overload situation. The user equipment will not typically re-check the system information to see if it is unbarred but will access straight away after the delay period expires.

In some embodiments of the invention, various combinations of the above two modes are be used. For example, the spread mode may be switched on or off by the network. When the spread mode is off, the barred mode may be used, and the delay may not necessarily be subject to scaling by the parameter. The barred mode may operate in a similar way to existing barred mode, and scaling by the parameter may only be applied when spread mode is active.

In another embodiment, barred mode is always used, and scaling of T_barred by the parameter may be switched on or off by the network.

In an embodiment of the invention, the value of T_Maximum is calculated by multiplying the percentage of access classes barred, by a constant “K”, where K is a positive real number. For example, the percentage of access classes barred may be 10% if 1 class is barred and 100% if 10 classes are barred.

In an embodiment of the invention, the delay may be determined in further dependence on a category of user equipment by assigning a weight to a category. The delay may be determined on the basis of a combination of categories, such as for example, allocating a shorter delay to devices that are members of category A but not members of category B than is allocated to devices that are members of both category A and category B. As another example, a longer delay may be allocated to devices that are members of category C and category B than to devices that are members of category B and not category C. The categories may be A, B or C, and may be defined as follows. Category A may indicate that the user equipment is configured to enable barring of access according to a class, for example that the user equipment is configured for EAB. Category B may indicate that the user equipment is not camped in a Home Public Land Mobile Network (HPLMN) of the user equipment and also not camped in an equivalent Public Land Mobile Network (ePLMN) related to said HPLMN. Category C may indicate that the user equipment is not camped in a Home Public Land Mobile Network (HPLMN) of the user equipment, not camped in an equivalent Public Land Mobile Network (ePLMN) related to HPLMN, and not camped in a most preferred PLMN for the user equipment. So, Category A may be all devices, such as MTC devices, which are configured for a scheme of access class barring, such Extended Access Barring (EAB). EAB is an access class barring scheme that may be applied to either UTRAN or E-UTRAN radio access networks. Category B may be all devices configured for EAB which are neither part of the Home Public Land Mobile Network (HPLMN) nor an equivalent PLMN (ePLMN) for the user equipment of which the radio access network is a part. Category C may be all devices configured for EAB which are neither part of their HPLMN nor an equivalent PLMN (ePLMN), nor the PLMN listed as most preferred PLMN of the country where the UE is roaming in the operator-defined PLMN selector list on the SIM/USIM.

Category A may have the smallest weight as it would apply to the largest number of devices, and C may have the highest weight as it would apply to the smallest number of devices, and as these devices could be considered as lower priority to the operator of the PLMN of which the radio access network is a part. A higher weight would result in a higher scaling parameter for the delay.

Embodiments of the invention may be applicable to UMTS, and to both LTE Time Division Duplex (LTE TDD) and LTE Frequency Division Duplex (LTE FDD).

In an embodiment of the invention, EAB related information may be included in a broadcast channel (BCCH), for LTE and UMTS networks. The information can include data items, such as a first Information Element (IE) in the broadcasting channel that contains, for example, 10 or 16 bits for bitmapping ACs 0-9 or 0-15, to control each class barred and not barred by network. Further information may include an indicator, that is an Information Element (IE), in the broadcasting channel relates to the categories A, B and C of user equipment for the classes indicated as barred in the first IE. The categories A, B and C may indicate priorities, where for example category C has the least priority and can endure a longer delay of time after barred, and B has the next lowest priority.

The information may include a timer range parameter, T_Maximum, which indicates to user equipments the largest delay of a range of delays.

In an embodiment of the invention, there are two modes for EAB. In Mode 1, access attempts are barred, and in Mode 2, access attempts are spread over time. In Mode 2, the broadcast EAB timer range is decided by the network based on the barred number of classes. At the UE side the barred time may be determined at each UE based on the broadcast EAB timer range and A,B,C categories by the relationship T_barred=M*rand, where M is an adjusting integer that could be related to the category of user equipment and rand is the uniform random number chose by UE in a range from 0, to T_Maximum.

In an embodiment of the invention, the delay set on a timer may be related linearly to the network jamming situation, as described above, that is to say the value of T_Maximum is calculated by multiplying the percentage of access classes barred, by a constant “K”, where K is a positive real number.

Alternatively, a value of the “T302” timer, which is a timer present in the radio access network, may be used to calculate the maximum delay range. The following formula may be used:

T_Maximum=M×Number_of_classes_barred×T302 timer

where M is an adjusting integer that could be related to the category of user equipment. In existing LTE systems, the default value of the T302 timer is typically 4000 msec. In an embodiment of the invention, the default value of the T302 timer may be used in the above formula, but other values may be used.

Examples will be now be given to illustrate the calculation of T_Maximum according to an embodiment of the invention. In a first example, M is given as 2 and there is only one class is barred, so that T_Maximum=2×1×T302 timer (msec). The user equipment will choose randomly from the range from 0 to twice the T302 timer value. In a second example, there are 5 classes barred, and the user equipment will choose randomly in from the range from 0 to five times the T302 timer value. In addition if it is indicated that only categories B and C are barred, then the timer can be set with larger M. For example, the M can be 4 so user equipment in categories B and C will choose from a range at the first example case from 0 to (4×1×T302), and in the second example from a range from 0 to (4×5×T320).

In an alternative embodiment, the following formula is used to calculate the maximum delay range:

T_Maximum=M×2̂Number_of_classes_barred×T302 timer

where M is an adjusting integer that reflecting the category of a user equipment. According to this formula, the maximum delay range is scaled by a factor of two to the power of the number of classes barred.

Alternatively, the following formula may be used, that does not use the T302 timer value:

T_Maximum=M×Number_of_classes_barred,

where M is an adjusting integer non-linear array which could be related to the category of user equipments. For example, the array M could be: [200, 400, 600, 1000, 2000, 4000, 8000, . . . ] millisecond which associated to MTC user equipments in three categories. For example, if M is given as 4000 and if there is one class is barred, then T_Maximum=4000×1 (msec). The user equipment will choose randomly from a range 0 to 4000 ms. If there are 5 classes barred, then a user equipment will choose randomly from the range 0 to 5×4000 (msec). In addition if the category indicates that only categories B and C are barred, then the timer can be set with larger M, for example in above case, the M can be 8000 so those user equipments of categories B or C will choose from a range at the example from 0 to 8000, and in the second example from 0 to 5×8000.

In an embodiment of the invention, when a user equipment configured for EAB, such as a MTC user equipment, receives the broadcast information relating to EAB, it will first check if the user equipment belongs to the barred classes and/or categories. If it does, then it will randomly choose a number T_barred from a range from 0 to the broadcast timer maximum range value T_Maximum. The user equipment then compares the value T_barred with a MTC device scheduled data transmission period T_period, if it is already defined and embedded in the device. If the timer range is smaller than T_period then the user equipment will be in a barred mode and wait until the T_barred period expires and try the access again. If the timer range T_barred is larger than the T_period, then the user equipment will be in a barred mode and wait till the 2×T_period time expires and try the access again.

In an embodiment of the invention, an EAB scheme may re-use a so-called eWaitTimer that is primarily used for resolving overload issues in the Core Network (CN). An advantage of reusing the eWaitTimer is that, in the case of shared networks, it is possible that a core network overload may correlate with a radio access network (RAN) overload and therefore at the Non Access Stratum (NAS) layer, the EAB scheme could be activated by a CN overload situation. In such a case, the eWaitTImer may be re-used in the radio access network and the timer may be broadcast to user equipments requesting access.

For example, if the EAB scheme is trigged by CN overload, then the NAS could send the eWaitTimer to the Access Stratum (AS) and the network broadcasts it to the user equipment devices that are going to send Radio Resource Control (RRC) connecting request messages. If T_Maximum is set to equal the eWaitTimer value, then user equipments in classes 0-9 will choose from the timer range of 0 to 1800 s, typically with steps of 1 s. If the priority of user equipment categories need to be considered, then for example category A devices may choose from the range 0 to (0.5×T_Maximum), and user equipments of categories B and C may use longer waiting time for another access opportunity by choosing from the range (0.5×T_Maximum) to T_Maximum.

Embodiments of the invention may have the advantage that they may be applicable to UMTS, LTE and other radio technology standards; they may be used to distribute access requests so as to make better use of the radio resources, and they may be suitable for barring user equipments with periodical access request characteristics, such as for paging.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of assisting management of congestion in a radio access network comprising at least a plurality of user equipments, each of said plurality of user equipments being configured to have one of a plurality of classes, and the radio access network being capable of being configured to bar access, at least temporarily, from a respective user equipment according to the class of the respective user equipment in order to reduce congestion, by transmitting equipment class barring data which indicates at least one class of user equipment which is to be barred,
the method comprising, at a user equipment:
holding user equipment class data indicating a given class of the user equipment;
receiving signalling data including an equipment class access barring data item which indicates that said given class of user equipment is to be barred, and one or more additional data items indicative of loading of the radio access network;
matching the given user equipment class to said equipment class barring data item, and in response thereto setting a barred status at the user equipment; and
in response to said barred status setting, determining a delay time for an attempt to access the radio access network, based at least in part upon said one or more additional data items.

2. A method according to claim 1, wherein said additional data items comprise a parameter related to which class or classes of user equipment have access to the radio access network barred by the configuration of the radio access network, and wherein said delay time is based at least in part on said parameter.

3. A method according to claim 2, wherein said parameter is determined by a process comprising quantifying a number of classes of user equipment for which access to the radio access network is barred.

4. A method according to claim 1, wherein said parameter is determined by a process comprising identifying a class of user equipment for which access to the radio access network is barred, the identified class being a class which indicates a more heavily loaded state of the radio network than other classes of user equipment for which access to the radio access network is barred.

5. A method according to claim 1, wherein said delay time is related to said one or more additional data items by a predetermined relationship, plus an additional delay such that the attempt to access the radio access network occurs at a periodically occurring allowed transmission time.

6. A method according to claim 1, the method comprising:
determining a maximum value of a range of delay times from said one or more additional data items; and
selecting said delay time from the range of delay times.

7. A method according to claim 6, wherein said determining the maximum value of a range of delay times is by multiplication of a constant by two raised to the power of a parameter derived from said one or more additional data items.

8. A method according to claim 1, wherein said one or more additional data items comprise a delay time value.

9. A method according to claim 1, wherein said one or more additional data items comprise user equipment barring data items relating to classes of user equipment other than said given classes.

10. A method according to claim 9, the method comprising:
determining a parameter related to a number of classes of user equipment for which access is barred from said one or more additional data items; and
determining said delay is on the basis of said parameter.

11. A method according to claim 1, wherein said determination of the delay time is in further dependence on the class of the user equipment performing said attempt to access the radio access network.

12. A method according to claim 1, wherein said determination of the delay is in further dependence at least on whether or not the radio access network is part of the Home Public Land Mobile Network (HPLMN) for the user equipment performing said attempt to access the radio access network.

13. A method according to claim 12, wherein said further dependence comprises dependence on a delay factor received at the user equipment from the radio access network, said delay factor being applicable to a respective category or categories of the user equipment, the respective category or categories being selected from:
a first category indicating that the user equipment is configured to enable barring of access according to a class;
a second category indicating that the user equipment is not camped in a Home Public Land Mobile Network (HPLMN) of the user equipment and not camped in an equivalent Public Land Mobile Network (ePLMN) related to said HPLMN; and
a third category indicating that the user equipment is not camped in a Home Public Land Mobile Network (HPLMN) of the user equipment, not camped in an equivalent Public Land Mobile Network (ePLMN) related to HPLMN, and not camped in a most preferred PLMN for the user equipment.

14. User equipment for assisting management of congestion in a radio access network comprising at least a plurality of user equipments, each of said plurality of user equipments being configured to have one of a plurality of classes, and the radio access network being capable of being configured to bar access, at least temporarily, from a respective user equipment according to the class of the respective user equipment in order to reduce congestion, by transmitting equipment class barring data which indicates at least one class of user equipment which is to be barred,
the user equipment comprising at least one processor and at least one memory including computer program code, the at least one memory and the computer program code configured to, with the at least one processor, cause the user equipment to at least:
hold user equipment class data indicating a given class of the user equipment;
receive signalling data including an equipment class access barring data item which indicates that said given class of user equipment is to be barred, and one or more additional data items indicative of loading of the radio access network;
match the given user equipment class to said equipment class barring data item, and in response thereto setting a barred status at the user equipment; and
in response to said barred status setting, determine a delay to an attempt to access the radio access network by a delay time, based at least in part upon said one or more additional data items.

15. User equipment according to claim 14, wherein said user equipment is a Machine Type Communication (MTC) user equipment.

16. User Equipment according to claim 15, wherein said radio access network operates according to a 3GPP standard and the user equipment has an Access Class in the range 0 to 9.

17. Apparatus for assisting management of congestion in a radio access network comprising at least a plurality of user equipments, each of said plurality of user equipments being configured to have one of a plurality of classes, and the radio access network being capable of being configured to bar access, at least temporarily, from a respective user equipment according to the class of the respective user equipment in order to reduce congestion, by transmitting equipment class barring data which indicates at least one class of user equipment which is to be barred,
the apparatus comprising at least one processor and at least one memory including computer program code, the at least one memory and the computer program code configured to, with the at least one processor, cause the apparatus to at least:
transmit an equipment class access barring data item which indicates that said given class of user equipment is to be barred;
determine a parameter indicative of loading of the radio access network;
transmit said parameter, along with said equipment class access barring data item, to delay an attempt to access the radio access network by a barred class of user equipment dependent on said parameter.

18. Apparatus according to claim 17, wherein said parameter is determined from knowledge of which class or classes of user equipment have access to the radio access network barred by the configuration of the radio access network.

19. Apparatus according to claim 18, wherein said parameter is determined by a process comprising quantifying a number of classes of user equipment for which access to the radio access network is barred.

20. Apparatus according to claim 17, wherein the apparatus comprises a fixed infrastructure part of the radio access network.
